(19) United States
(12) Patent Application Publication
(10) Pub. No.: US 2024/0374067 A1
(43) Pub. Date: Nov. 14, 2024

(54) BLACKOUT PLEATED CURTAIN FABRIC AND PLEATED CURTAIN SYSTEM COMPRISING THIS FABRIC

(71) Applicant: BERTEKS TEKSTIL SANAYI VE TICARET ANONIM SIRKETI, Osmangazi (TR)

(72) Inventor: Burcu ERDEBIL, Osmangazi (TR)

(21) Appl. No.: 18/492,241

(22) Filed: Oct. 23, 2023

(30) Foreign Application Priority Data
May 12, 2023 (TR) 2023/005365

(51) Int. Cl. A47H 23/14

(52) U.S. Cl. CPC A47H 23/14

(57) ABSTRACT

Disclosed is an innovation in the pleated curtain fabric used in areas such as all doors, windows, glass balconies, etc., and relates to a pleated curtain fabric that does not allow light to pass through the rope holes required for the operation of the pleated curtain system by folding the fabric produced in one piece with a certain repetition pattern (pleating) and joining it from the determined places (gluing, sewing, etc.) and a pleated curtain system utilizing the fabric.

### FIELD OF THE INVENTION

The invention relates to an innovation in the pleated curtain fabric used in areas such as all doors, windows, glass balconies, etc., and relates to a pleated curtain fabric that does not allow light to pass through the rope holes required for the operation of the pleated curtain system by folding the fabric produced in one piece with a certain repetition pattern (pleating) and joining it from the determined places (gluing, sewing, etc.) and the pleated curtain system comprising the said fabric.

### BACKGROUND OF THE INVENTION

Curtains are one of the most necessary and stylish accessories of all spaces and also the most important part of decoration works. Today, pleated curtain systems are preferred for movable or folding windows, doors, ceiling windows, balcony and winter garden windows, sliding door windows or simple interior designs.

Pleated curtain systems consist of fabric produced with different techniques in the middle part, profiles made of aluminum or a different material in the lower and upper parts, mounting profiles or mounting apparatus and other ropes and plastic apparatus that complete the system. The pleated fabric in the middle part is fitted into the fabric channels in the upper and lower profiles to ensure the integrity of the curtain system.

In the present applications, light leaks through the rope holes on standard pleated fabrics (FIG. 1) and this creates a serious problem considering that the purpose of the curtain is to control the light. Honeycomb fabrics have been produced in order to prevent light leaking through the rope holes in a known technique, but in the production with this technique, a cellular fabric is made by cutting the fabric or nonwoven surface pieces in certain sizes and gluing them together. This technique has prevented light leakage through the rope holes, but the process of cutting, matching and gluing the fabric structures that will form the honeycomb structure makes the production very tedious and it has been determined that this method is not very suitable for the curtain sector. In these products, which have been exposed to sunlight for many years, it has been observed that the fabric parts are separated due to the loss of the properties of the adhesive materials that enable the parts to be bonded to each other over time and that it is impossible to clean them with washing in case of contamination and staining.

Consequently, due to the drawbacks mentioned above and the inadequacy of the existing solutions, it has become necessary to make an improvement in the relevant technical field.

### BRIEF SUMMARY OF THE INVENTION

The invention is inspired by existing situations and aims to solve the above-mentioned problems.

The objective of the invention is to provide a pleated curtain fabric and a pleated curtain system comprising the said fabric. The curtain fabric is produced in the same way as standard pleated fabrics, and after coating or finishing processes, it is subjected to pleating process in the pleating machine. While all the folds are made in the same length in standard pleated fabrics, the fold of the fabric of the invention will be made according to a certain repetition pattern, and on the visible surface of the curtain on the front part, there are only the peaks and troughs of the pleats; on the back part, there are the rope holes required for the pleated curtain system.

The objective of the invention is to provide a blackout pleated curtain fabric and a pleated curtain system comprising the said fabric, the pleat fold width of which can be varied according to demand. In standard pleated curtain systems, the pleat fold width is produced in such a way that the pleat fold width is the same everywhere on the fabric. However, the biggest disadvantage of this system is that light leaks through the rope holes required for the curtain system to work. With the invention, the pleat fold width of the fabric can be produced by adjusting the pleat fold width with a repeating pattern and a repeating pleat pattern can be created in the fabric having one large and one small pleat. In addition, this pleating pattern can be readjusted according to the demand by changing the folding size of the large pleat and the folding size of the small pleat. After the production is made according to the determined pleat repetition pattern, the production is completed by joining (gluing, sewing, etc.) the two wings of the large pleat along the width of the fabric at the determined size. The intersection of the small pleat and the large pleat forms the pleats that are visible when viewed from the front side of the fabric and the rope holes on the back side are not visible when viewed from the front. Since the holes required for the pleated curtain system will be opened on the back side and are not visible when viewed from the front side, light leakage is prevented.

In order to achieve the objectives described above, the invention is a blackout pleated curtain fabric that is formed from a pleated curtain fabric produced by weaving, knitting or other techniques, by joining the opposite wings of the large pleats together after the pleating process is carried out as a whole according to a certain repetition pattern without any cutting/shredding/dividing into small pieces, where the rope holes required for the operation of the pleated curtain system remain on the back side (and the front side does not allow light to leak through it, wherein the said fabric comprises the following:
small pleats which are folded at the small pleat fold size according to the pleating repetition pattern of the fabric,
large pleats which are folded at the large pleat fold size according to the pleating repetition pattern of the fabric,
the front side peaks which are the intersection of the small pleat and the large pleat (which appear as the peak of the fabric on the front face of the fabric,
front side depressions which appear as depressions on the front side of the fabric which are the intersection point of the wings (3.3) of the small pleat and the large pleat joined together,
the combined wings of the large pleat joined across the width of the fabric by gluing or sewing the opposite wings of the large pleat together at the level of the depression point of the front side,
rope holes opened on the combined wings of the large pleat on the back side of the fabric.

The structural and characteristic features and all advantages of the invention will be more clearly understood by means of the figures given below and the detailed description written by making references to these figures, and therefore, evaluation should be made by considering these figures and detailed description.

### BRIEF DESCRIPTION OF THE SEVERAL VIEWS OF THE DRAWINGS

FIG. 1 is the view of the standard pleated curtain fabric in existing applications and the rope holes on the front side.

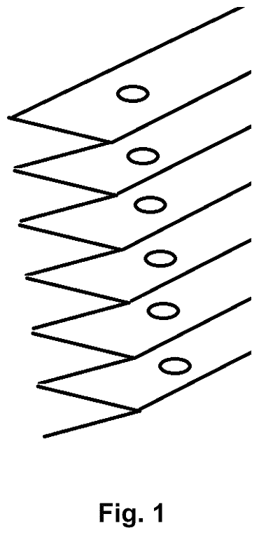

FIG. 2 is the side view of the fabric of the invention after the folding process according to repetition pattern.

FIG. 3 is the side view of the large pleats after joining and the rope holes on the back of the pleated curtain fabric of the invention.

FIG. 4 is a side view in three dimensions of the large pleat after it has been assembled and a view of the rope holes left behind the fabric.

FIG. 5 is a view of the pleated curtain system incorporating the fabric of the invention.

### DESCRIPTION OF PART REFERENCES

1.1. Pleated curtain fabric
2.1. Front side peak
2.2. Large pleat fold size
2.3. Small pleat fold size
2.4. Small pleat
2.5. Large pleat
2.6 Front face depression point
3.1. Front Side
3.2. Back Side
3.3. Combined wings
4.1. Rope holes
6.1. Profile
6.2. Mounting apparatus
6.3. Rope

### DETAILED DESCRIPTION OF THE INVENTION

In this detailed description, the preferred embodiments of the pleated curtain, which is the subject of the invention, are described only for a better understanding of the subject matter.

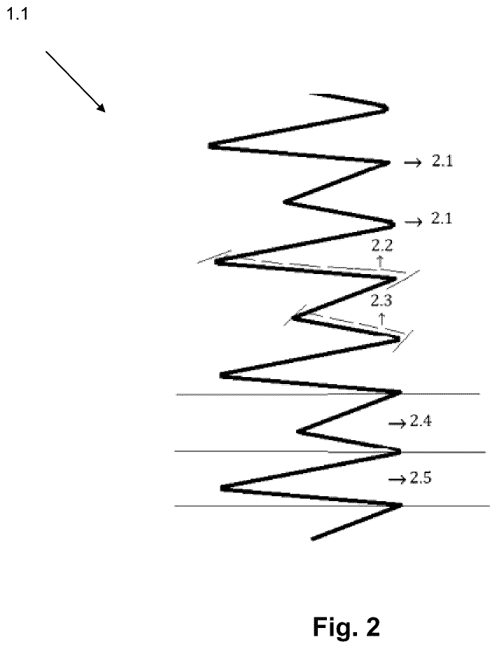

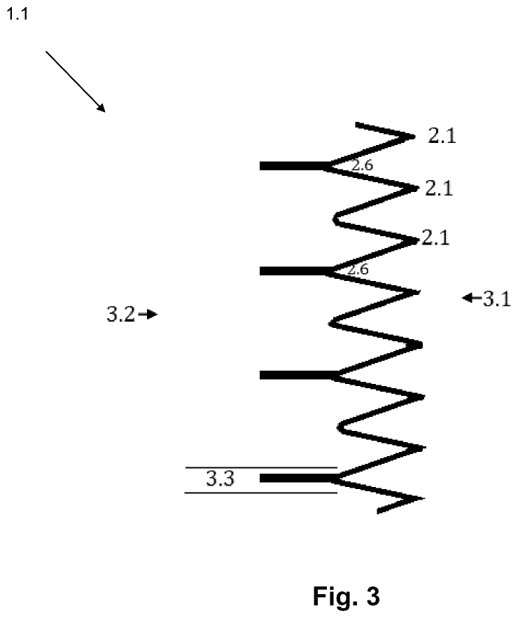

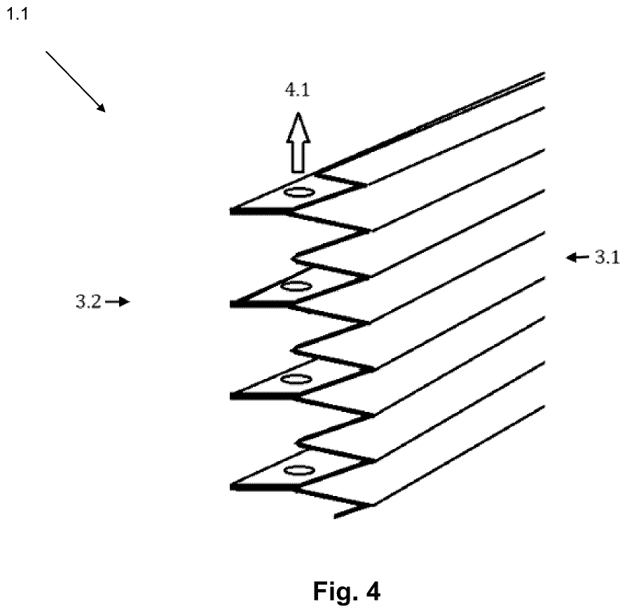

The invention is a blackout pleated curtain fabric (1.1) that is formed from a pleated curtain fabric produced by weaving, knitting or other techniques, by joining the opposite wings of the large pleats (2.5) together (FIG. 3) after the pleating process (FIG. 2) is carried out as a whole according to a certain repetition pattern without any cutting/shredding/dividing into small pieces, where the rope holes (4.1) required for the operation of the pleated curtain system remain on the back side (3.2) (FIG. 4) and the front side (3.1) does not allow light to leak through it, wherein the said fabric comprises the following:
small pleats (2.3), which are folded at the small pleat fold size (2.3), according to the pleating repetition pattern of the fabric,
large pleats (2.5), which are folded at the large pleat fold size (2.2), according to the pleating repetition pattern of the fabric,
the front side peaks (2.1), which are the intersection of the small pleat (2.4) and the large pleat (2.5), which appear as the peak of the fabric on the front face of the fabric (3.1),
front side depressions (2.6), which appear as depressions on the front side of the fabric (3.1), which are the intersection point of the wings (3.3) of the small pleat (2.4) and the large pleat (2.5) joined together,
the combined wings (3.3) of the large pleat (2.5) joined across the width of the fabric by gluing or sewing the opposite wings of the large pleat (2.5) together at the level of the depression point (2.6) of the front side (3.1),
rope holes (4.1) opened on the combined wings (3.3) of the large pleat (2.5) on the back side of the fabric.

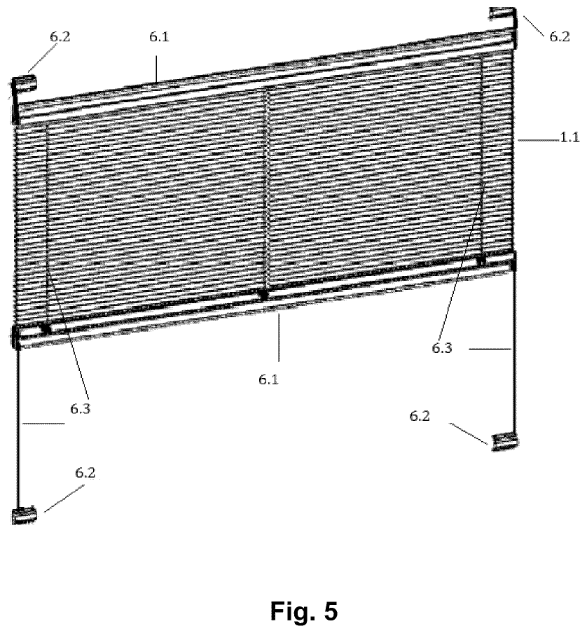

The invention is also includes a pleated curtain system (FIG. 5) that comprises the pleated curtain fabric (1.1) that does not leak light; a rope (6.3.) that allows the fabric (1.1) and profiles (6.1) in pleated curtain systems to be connected to each other and move; a profile (6.1) made of aluminum that allows the pleated curtain systems to stand rigidly and controls the opening and closing or other materials that will serve the same purpose (6.1); mounting apparatus (6.2) that allows the curtain to be mounted on the desired background.

The production of the blackout pleated curtain fabric (1.1) of the invention basically consists of three stages:
Pleating of pleated curtain fabric produced by weaving, knitting or other techniques without any cutting/shredding/dividing into small pieces as a whole and according to a certain repetition pattern;
Joining the wings of the large pleat;
Opening rope holes in the assembled pleat wing.

For the production of pleated curtain fabric (1.1), first of all, the fabric produced by weaving, knitting or other techniques is pleated as a whole without any cutting/shredding/dividing into small pieces. The pleating width of the fabric can be produced by adjusting the pleat fold width with a repeating pattern and a repeating pleat pattern can be created in the fabric having one large pleat (2.5) and one small pleat (2.4). In addition, this pleat pattern can be readjusted by changing the large pleat fold size (2.2) and small pleat fold size (2.3) according to the demand.

After the production is made according to the determined pleat repetition pattern, the production is completed by joining (gluing, sewing, etc.) the two wings of the large pleat (2.5) along the width of the fabric at the determined size. The intersection (2.1) of the small pleat and the large pleat forms the pleats that are visible when viewed from the front side (3.1) of the fabric and the rope holes (4.1) on the back side (3.2) are not visible when viewed from the front. Since the holes (4.1) required for the pleated curtain system will be opened on the back side and are not visible when viewed from the front side (3.1), light leakage is prevented.

If a standard pleat appearance is desired on the front side (3.1) of the pleated curtain, the large pleat fold size (2.2) is marked the same as the small pleat fold size (2.3) and the wings of the large pleat (2.5) are joined with each other. If it is not desired to see the standard size pleat length when viewed from the front side (3.1), the wings can also be joined by aligning from a different place.

The rope holes (4.1) that need to be opened for the operation of the pleated curtain systems are opened on the joined wings (3.3) of the large pleat, so that the rope holes are not visible when viewed from the front (3.1) and light leakage is prevented through these holes.

I claim:

1. A blackout pleated curtain fabric that is formed from a pleated curtain fabric produced by weaving, knitting or other techniques, by joining opposite wings of large pleats together after a pleating process is carried out as a whole according to a certain repetition pattern without any cutting/shredding/dividing into small pieces, where rope holes required for the operation of the pleated curtain system remain on a back side and a front side does not allow light to leak through it, wherein the said fabric comprises the following;
small pleats, which are folded at a small pleat fold size, according to the pleating repetition pattern of the fabric,
large pleats, which are folded at a large pleat fold size, according to the pleating repetition pattern of the fabric,
front side peaks, which are the intersection of the small pleat and the large pleat, which appear as the peak of the fabric on the front face of the fabric,
front side depressions, which appear as depressions on the front side of the fabric, which are the intersection point of wings of the small pleat and the large pleat joined together,
combined wings of the large pleat joined across the width of the fabric by gluing or sewing the opposite wings of the large pleat together at the level of a depression point of the front side,
rope holes opened on the combined wings of the large pleat on the back side of the fabric.

2. Pleated curtain system that comprises a rope that allows the pleated curtain fabric according to claim 1 and profiles in pleated curtain systems to be connected to each other and move; the profile made of aluminum which ensures the rigidity of the pleated curtain systems and controls their opening and closing or different materials that will serve the same purpose; a mounting apparatus that allows curtain mounting on the desired background.

3. Production method for the pleated curtain fabric according to claim 1, wherein the method comprises the following steps:
pleating of pleated curtain fabric produced by weaving, knitting or other techniques without any cutting/shredding/dividing into small pieces as a whole and according to a certain repetition pattern;
joining the wings of the large pleat;
opening rope holes in the assembled pleat wing.
